(19) United States
(12) Patent Application Publication
(10) Pub. No.: US 2007/0255042 A1
(43) Pub. Date: Nov. 1, 2007

(54) Production of chiral materials using crystallization inhibitors

(75) Inventors: Regina Valluzzi, Medford, MA (US); Liya Liu, Boxborough, MA (US)

Correspondence Address: WILMER CUTLER PICKERING HALE AND DORR LLP, 60 STATE STREET, BOSTON, MA, 02109, US

(73) Assignee: Evolved Nanomaterial Sciences, Inc., Cambridge, MA (US)

(21) Appl. No.: 11/641,344

(22) Filed: Dec. 19, 2006

Related U.S. Application Data
(60) Provisional application No. 60/785,669, filed on Mar. 24, 2006.
(60) Provisional application No. 60/751,545, filed on Dec. 19, 2005.

(51) Int. Cl. C07K 2/00

(52) U.S. Cl. 530/353

(57) ABSTRACT

A method is disclosed for producing a chiral gel. A polymer including chiral monomers, such as a protein, is dissolved to generate a sol, which is optionally dialyzed. The sol is contacted with a crystallization inhibitor that allows it to form a gel. The gel in wet or dried form is useful for performing chiral separations.

### RELATED APPLICATIONS

This application claims priority to U.S. Provisional Application No. 60/751,545, filed Dec. 19, 2005, and U.S. Provisional Application No. 60/785,669, filed Mar. 24, 2006. This application also relates to the U.S. patent application filed on even date herewith, entitled “Particulate Chiral Separation Material,” which also claims priority to U.S. Provisional Application Nos. 60/751,545 and 60/785,669. The contents of all three of these applications are incorporated by reference herein.

### BACKGROUND

1. Field

The field relates to chiral materials and methods of their manufacture. In particular, the field relates to chiral polymer materials for use in chiral separations.

2. Summary of Related Art

Chiral molecules have application in a variety of industries, including polymers, specialty chemicals, flavors and fragrances, and pharmaceuticals. Many applications in these industries require the isolation and use of single chiral isomers (enantiomers) of chiral compounds. Several methods are commonly used to obtain single enantiomers of chiral compounds. One method is chiral pool synthesis, which involves the use of libraries of chiral starting molecules to create new molecules of interest, while attempting to preserve their chiral centers. Often a “polishing” chiral resolution or separation step is required to provide a product of acceptable enantiomeric purity. A second method is chiral catalysis, which uses chiral catalysts to produce enantiomerically pure compounds. However, matching catalysts and target molecules can be difficult. A third method is chiral crystallization. In some cases, a racemate is complexed with another chiral compound that selects the desired enantiomer, resulting in a chemical distinction between the two enantiomers that allows one to crystallize out. In other cases, a solution is seeded with chiral crystals, causing the desired enantiomer to crystallize out preferentially. However, this approach works only for the approximately 10% of known compounds that crystallize into distinct enantiopure crystallites. A fourth method employs chiral chromatography, such as high performance liquid chromatography (HPLC), which is used in batch mode, or a continuous chromatographic process called simulated moving bed (SMB). SMB involves a number of large chiral HPLC columns run pseudo-continuously in parallel, with fluid inlet and outlet valves along the columns that are switched in a pattern that simulates motion of the solid bed inside the columns. All of these methods present scalability challenges, and no one method is generally applicable throughout scale-up from drug discovery to semi-preparative, pilot and production scale.

As a general matter, chiral recognition and selection of enantiomers is more demanding than most other forms of chemical interaction and recognition. Enantiomers are difficult to separate because they are topologically identical and differ only in their three dimensional geometry by the presence of a subtle “mirror image” symmetry. Thus, all aspects of their chemistry and separatory behavior appear identical except in the presence of a chiral environment, probe or ligand. A widely held theory suggests that for a chirally specific ligand or binding interaction, three separate sites are required per molecule, in order to distinguish the three dimensional nature of the difference between enantiomers. Indeed, most common chiral selector technologies rely on multi-point interactions between an enantiomeric analyte and, e.g., a chiral ligand.

The basic methods of chiral chromatography are HPLC, SFC (supercritical fluid chromatography) and SMB, with simulated moving bed processes employing supercritical fluid mobile phases also under development. All of these chromatographic separations processes can be used for preparative separations, that is, to fractionate and recover enantioenriched or chirally pure fractions from a starting mixture. SFC can be considered along with HPLC and SMB, as a technique that requires some degree of additional engineering to allow HPLC and SMB approaches with supercritical gases as a mobile phase or mobile phase component. The chiral chromatographic materials used in HPLC, SMB and their supercritical fluid analogs are in many cases the same. HPLC tends to be highly engineered and slow, with low capacity and low throughput, employing very small particles of weakly selective, highly chemically specific media. SMB provides higher throughput, but still tends to be highly engineered and costly, with an SMB apparatus typically being designed specifically for each pharmaceutical molecule to be separated at production scale.

In chromatography, a change of column or sorbent allows the system to separate different molecules. For non-chiral chromatography, there are general column types and materials that can address many molecules and sample mixtures to be separated using the same chromatographic material, and often the identical column. For example, reversed phase “C18” columns address the majority of molecules requiring non-chiral chromatographic separations. In these non-chiral approaches, changes in mobile phase composition are typically sufficient to address separation of different types of molecules. In contrast, chiral chromatographic separations use a large number of chiral stationary phases or chiral materials, where each type of chiral material has a much higher specificity and lower generality in the types of chiral molecules it can separate. Even within a class of molecules addressed by a particular chiral stationary phase, there may be individual molecules that can be separated well, marginally, and not at all, with no simple rationale for the success or failure of particular separations. There are some “general purpose” stationary phases for chiral HPLC that can separate a limited variety of compounds. However, specialized stationary phases are needed for a number of common chemical classes (as well as particular compounds within those classes), including acids, free amines, aromatic alcohols, bases, and certain hydrocarbon compounds.

Also, only some of the stationary phases are available as “bonded” media, in which a chiral selector is covalently bonded to silica. In many of the available stationary phases, the chiral selector is simply adsorbed to the silica surface via weak van der Waals interactions, thus limiting compatible solvents to those that will not dissolve off the non-bonded chiral selector. Moreover, bonding a chiral selector can affect its performance, for example, changing the shape of the area used for chiral recognition-based resolution. Thus, improved chiral selectivity, and broader applicability across various types of chiral analytes, of the materials used in the chromatographic stationary phase would be desirable.

There is indirect evidence that the shape of a chiral cavity can be selective for enantiomers by passively containing rather than actively binding the enantiomer. Most of these data come from studies on polymer or molecular imprinting. In these studies, an enantiomer is dissolved in a polymeric matrix, which is then solidified. The enantiomeric “guest” is extracted, leaving behind a polymer with a bias towards chiral cavities in its free volume. These “molecularly imprinted” materials have been found to be selective for enantiomers of the chiral compound used to create them and for closely related chiral molecules. Selectivity is increased when imprinting includes strong chemical interactions between the small molecule guest and the host matrix. The weak and specific selectivity of imprinted polymer materials in the absence of strong chemical interactions between guest and host is expected to be due to the limited flexibility of the polymer chains and the non-chiral free volume within the polymer, which dilute the effect of the chiral volume introduced by an enantiomeric guest species. When strong chemical interactions are introduced, the situation is in effect one where three or more binding sites are available in a small enough volume to recognize a chiral molecule, and the mechanism for selection reduces to the mechanism used in many ligand-functionalized chiral media.

In another chiral selection method, a chirally selective ligand is placed in a confined chiral environment to bias binding in an enantioselective manner. The chirally selective interactions proposed here are chemical and occur in a two dimensional environment (i.e., binding enantiomers by chiral ligands on a surface or ligands on a chiral surface). Clay based chiral selectors have been proposed, based on confinement of chirally selective molecules between partly exfoliated layers of a clay mineral. Thin film deposition of chiral arrangements of copper on a hard surface also has been proposed. Chiral selection using such materials may involve further functionalization of the chiral copper surface with chemical ligands to bind target analyte molecules.

In a few cases, well-defined chiral volumes have been created, for example, molecular scale tubes formed from the intertwined helices of polymer molecules, or chiral carbon nanotubes for potential organization into a membrane. Chiral “zeotypes” (like zeolites), and shape-based mechanisms like enzyme pockets also have been proposed as chiral selectors. Chiral selectivity in all of these cases relies on a close fit between the chiral selector cavity and the chiral analyte that involves a binding interaction. The discrete set of three or more binding sites indicated for typical chiral ligand-based selectivity is replaced by a large number of weaker, less specific van der Waals interactions. These technologies involving well-defined chiral volumes and tight “fits” between chiral analytes and selector cavities are limited in terms of the range of chemical entities that fit into the cavity in a given selector material, thus requiring many different types of selectors to cover a wide range of analytes.

Chirally selective materials potentially useful in chiral separations have been made from protein solutions using templating processes that allow for the formation of a chiral hydrogel at the interface between a hydrophobic liquid and a hydrophilic liquid (see WO 2004/041845, “Templated Native Silk Smectic Gels,” which is incorporated by reference herein). The hydrogels thus formed may have a material superstructure generated by an array of twisting molecules, and may exhibit a long-range ordered structure including layers and/or nanoscale channels. The chiral structure of these hydrogels and dried solids obtained therefrom allows for their potential use as chiral selectors. In these materials, chiral selectivity is linked to the materials morphology, and notable differences in chiral selectivity are observed when the structure of the material is altered.

The templating processes used to form these gels can be cumbersome and labor-intensive, and involve the use of toxic or environmentally unfriendly organic solvents in a constrained environment. Templating is performed in a container that can accommodate the templating liquids, and includes the formation of a still, stable, and cohesive liquid-liquid interface. Accordingly, the shape and format of templated materials is limited, and large scale processing is difficult. Moreover, the interfacial nature of the templating process may generate structures that have channels that are relatively flat, which may affect chiral selectivity. Furthermore, the templated materials exhibit inhomogeneity due to a “core/skin” effect at the interface. A barrier layer forms as a skin on the interface, and then templates into the aqueous polymer solution as bulk hydrogel. The presence of two distinct layers with different properties can cause differences in the material properties at the interface and within the bulk. A “gradient” chiral structure may result, with the material structure varying with distance from the interface. Templated materials also may exhibit levels of chemical stability, swelling in aqueous solvents, and/or purity that could be improved upon for certain applications.

Further improvements in chiral materials and chiral separation performance are desired.

### SUMMARY

Disclosed herein are new chiral materials, methods for making the materials, and systems and methods for using the materials to perform chiral separations. The materials are chirally selective, i.e., capable of distinguishing between and preferentially interacting with one of two or more enantiomers of the same compound. The methods for making chirally selective materials described herein advantageously do not require an interface or templating surface. Rather, these methods include the addition of a crystallization inhibiting agent to a liquid containing a polymer. The additive discourages crystallization and allows the polymer solution to form a gel. In at least some instances, temperature is used to trigger gelation. Replacing the templating step previously used to form chiral hydrogels in this way allows for reproducible formation of homogeneous gels, i.e., without the core/skin or gradient structure that results from templating. In one or more embodiments, because they are not templated, the gels lack an alignment effect that competes with chiral twisting in the material. Also, gels can be formed in a wide variety of shapes and formats (e.g., molded shapes, monolithic shapes, thick films, coatings, membranes, and powders), without being constrained by the shape of molds used to form templated interfaces. In at least some instances, yield is also improved compared to templating. For example, a yield of about 60% is obtained in some embodiments, compared to a yield of about 20% for templated processes (with yield reflecting the amount of polymer raw material recovered in the form of the final chirally selective material).

Chirally selective materials produced as described herein are suitable for use in a variety of chiral separation applications. In one or more embodiments, the materials provide sufficient chiral selectivity that they are suitable for use not only in highly engineered applications with large numbers of effective equilibrium separation stages, such as typical chromatography, and SMB, but also in applications which require less engineering and provide fewer effective equilibrium separation stages, such as multistage filters, staged membranes, and diafiltration. Straightforward applications such as simple membranes, simple contact sorbents, low pressure/low plate number chromatography, and filtration with a single stage or small number of stages are also enabled by the materials. In contrast, the chiral selectivity provided by chiral materials made by templating processes generally is only sufficient for use in moderately to highly engineered formats that employ a large number of effective separation stages—at least about 10 equivalent “plates,” which are equilibrium mass transfer separation “steps” that occur approximately sequentially. More typically, chiral materials made by templating processes require about 20 to about 50 equivalent plates to achieve chiral separation of 99% EE. In contrast, conventional chiral materials typically require hundreds to thousands of equivalent plates, whereas the materials made according to one or more embodiments herein often require fewer than about 20 equivalent plates, and often can achieve an acceptable EE in fewer than about 5 equivalent plates. Chirally selective materials produced according to one or more embodiments herein also provide improved properties with respect to stability, contaminant leaching, and swelling in aqueous solution compared to chiral materials produced by templating processes.

One aspect provides a method for producing a chirally selective material. The method includes dissolving a polymer in an interactive solvent to generate a sol. The polymer includes at least about 30% chiral monomers of the same chiral orientation, and the sol includes at least about 3 weight % polymer. The sol is dialyzed to remove a component of the interactive solvent. A crystallization inhibitor is introduced into the sol, and the sol is allowed to form a chiral gel.

In some embodiments, the gel has a substantially homogeneous chiral structure. In some embodiments, gel formation is not initiated at an interface between the sol and an immiscible liquid. In certain embodiments, the sol is cast into a container to obtain a gel having the shape of the container.

In some embodiments, the gel is formed at a temperature between about 15° C. and about 50° C. In certain embodiments, the sol includes at least about 10 weight %, for example, at least about 15 weight %, polymer. In some embodiments, the interactive solvent includes an aqueous salt solution that maintains separation between the polymer molecules in solution, but does not denature the polymer molecules. In some instances, the salt is selected from the group consisting of sodium salts, potassium salts, calcium salts, lithium salts, magnesium salts, manganese salts, and mixtures thereof. In certain embodiments, dialyzing the sol removes at least about 60% of the salt. In some embodiments, the sol is concentrated.

In some embodiments, the crystallization inhibitor is selected from the group consisting of acids, bases, and salts. For example, the crystallization inhibitor is an acid or a base. In certain embodiments, the crystallization inhibitor is selected from the group consisting of hydrochloric acid, acetic acid, nitric acid, phosphoric acid, carbonic acid, formic acid, propionic acid, sulfuric acid, trifluoroacetic acid, AlCl₃, FeCl₃, and mixtures thereof. In certain embodiments, the crystallization inhibitor is selected from the group consisting of salts of hydroxides, phosphates, carbonates, and mixtures thereof.

In some embodiments, the gel is washed. In some instances, the gel is dried to form a resin, which is optionally ground to form particles. In certain embodiments, the gel is annealed. In some cases, annealing is performed in an annealing solvent, for example, including an alcohol. In some instances annealing is performed at a temperature between about 15° C. and about 70° C. In some embodiments, the gel is contacted with a chemical modification agent to chemically functionalize the gel. In certain embodiments, the chemical modification agent is a silanizing agent, a crosslinking agent, a hydrophobic coating agent, a coupling agent, or a mixture thereof. In some instances, an enzyme or catalyst is immobilized in the gel.

In certain embodiments, the polymer is a naturally occurring polymer, for example, a collagen, keratin, silk, seroin, or chorion. In some instances, the polymer originates from a species of Bombyx, Antherea, Gonometa, Borocera, Anaphe, Argemia, Argiope, Tetragnatha, Gasteracantha, Araenea, Nephila, Embiidina, or Hymenoptera. A chirally selective material made by the method is also provided.

Another aspect provides a method for producing a chirally selective material. The method includes dissolving a polymer in an interactive solvent to generate a sol. The polymer includes at least about 30% chiral monomers of the same chiral orientation, and the sol includes at least about 10 weight % polymer. A crystallization inhibitor is introduced into the sol, and the sol is allowed to form a chiral gel.

In some embodiments, the gel has a substantially homogeneous chiral structure. In some embodiments, gel formation is not initiated at an interface between the sol and an immiscible liquid. In certain embodiments, the sol is cast into a container to obtain a gel having the shape of the container.

In some embodiments, the sol includes at least about 15 weight %, for example, at least about 20 weight %, polymer. In certain embodiments, the weight ratio of crystallization inhibitor to polymer is greater than about 5%. In some instances, the gel is formed at a temperature between about 30° C. and about 60° C. In some instances, formation of the gel from the sol takes at least about 4 hours. A chirally selective material made by the method is also provided.

Another aspect provides a preformed article including a cast or molded chirally selective material. The chirally selective material includes a polymer containing at least about 30% chiral monomers of the same chiral orientation. The polymer forms a multilayered structure having internal chiral pores or channels with a diameter between about 5 nm and about 50 nm, for example between about 5 nm and about 30 nm.

In some embodiments, the chirally selective material has a substantially homogeneous chiral structure. In some embodiments, the chiral structure of the chirally selective material lacks an alignment effect that competes with chiral twisting in the material. In certain embodiments, the chirally selective material is a gel or a resin. In some embodiments, the chirally selective material is a liquid crystalline ordered solid. In certain embodiments, the multilayered structure includes layers of molecularly oriented polymer defining an interlayer region including chiral pores or channels having a diameter between about 5 nm and about 30 nm. In some instances, the chirally selective material is crosslinked. In certain embodiments, the polymer is a naturally occurring polymer, for example, a collagen, keratin, silk, seroin, or chorion. In some embodiments, the internal chiral pores or channels are chemically modified. For example, in some cases the internal chiral pores or channels are coated with an agent to modify the surface properties of the chiral pores or channels. In certain embodiments, the chirally selective material includes an enzyme or catalyst immobilized in the material. In some instances, the chirally selective material is in the form of a membrane.

Still another aspect provides a method of performing chiral separation. A mixture of enantiomers is contacted with a chirally selective material. The chirally selective material includes a polymer containing at least about 30% chiral monomers of the same chiral orientation. The polymer forms a multilayered structure having internal chiral volumes that are between about 4 and about 60 times the size of the enantiomers to be separated. Predominantly a first enantiomer is isolated within the chirally selective material (i.e., more of a first enantiomer is found within the chirally selective material compared to a second enantiomer).

In some embodiments, the first enantiomer isolated within the chirally selective material is extracted. In certain embodiments, contacting the mixture of enantiomers with the chirally selective material includes allowing the enantiomers to diffuse selectively into the material in a solvent. In some embodiments, predominantly a second enantiomer is recovered from the bulk solvent (i.e., more of the second enantiomer than the first enantiomer is recovered from the bulk solvent).

In some embodiments, the chirally selective material has a substantially homogeneous chiral structure. In certain embodiments, the chiral structure of the chirally selective material lacks an alignment effect that competes with chiral twisting in the material. In some instances, the internal chiral volumes are between about 20 and about 50 times the size of the enantiomers to be separated. In some embodiments, the chirally selective material forms a membrane. Predominantly a first enantiomer is isolated within the membrane and predominantly a second enantiomer passes through the membrane.

Yet another aspect provides a chiral separations column containing a chirally selective material. The chirally selective material includes a polymer containing at least about 30% chiral monomers of the same chiral orientation. The polymer forms a multilayered structure having internal chiral pores or channels with a diameter between about 5 nm and about 50 nm.

In some embodiments, the chirally selective material has a substantially homogeneous chiral structure. In some embodiments, the chiral structure of the chirally selective material lacks an alignment effect that competes with chiral twisting in the material. In some embodiments, the chirally selective material is in the form of a cast or molded preformed article. In some embodiments, the chirally selective material is in the form of particles. In certain embodiments, the particles have a size of about 25 microns or less. In some instances, the column provides a separation efficiency greater than about 10% EE. In some instances, the chirally selective material is crosslinked. In certain embodiments, the chirally selective material is swollen in a solvent.

Yet another aspect provides a composition including a chirally selective material. The chirally selective material includes a polymer containing at least about 30% chiral monomers of the same chiral orientation. The polymer forms a multilayered structure having internal chiral pores or channels with a diameter between about 5 nm and about 50 nm. The chiral structure of the chirally selective material lacks an alignment effect that competes with chiral twisting in the material.

### BRIEF DESCRIPTION OF THE DRAWING

The following figures are presented for the purpose of illustration only, and are not intended to be limiting.

FIG. 1 is a photograph of a gel made according to certain embodiments. The gel has been dried by supercritical fluid extraction.

FIG. 2 is an HPLC chromatogram showing separation of benzoin using a chiral material made as described in Example 1.

FIG. 3 is an HPLC chromatogram showing separation of DL-lysine using a chiral material made as described in Example 1.

### DETAILED DESCRIPTION

Chirally Selective Materials

Chiral materials are produced according to one or more embodiments herein. For example, a precursor polymer is dissolved, and then contacted with a crystallization inhibitor that promotes formation of a gel having chiral pores or channels in the solidified form. The gel is suitable for use as a chiral separator material in wet or dried (resin) form. In at least some embodiments, the gel forms a substantially uniform (i.e., lacking the core/skin or gradient structure that results from templating) organization of chirally selective material. In certain embodiments, the gel is a chiral, long-ranged, nanoscale patterned material having internal chiral volumes several-fold larger than chiral molecules to be separated. In some embodiments, the gel has internal chiral volumes that are less than about 50 times the size of a chiral molecule to be separated. For example, pores or channels having diameters that are less than about 40 times, about 30 times, about 20 times, about 10 times, or about 5 times the size of a chiral molecule to be separated are used. Such chiral pores or channels having a volume of sufficient size to interact with chiral molecules, allowing separation of one enantiomer from another, are referred to herein as a “chiral volume.” In certain embodiments, the pores or channels have diameters between about 4 and about 60 times, for example, between about 20 and about 50 times the size of a chiral molecule to be separated. In some embodiments, the size (i.e., diameter) of the chiral pores or channels is between about 5 nm and about 50 nm, for example, between about 5 nm and about 30 nm, whereas many enantiomers to be separated are smaller than about 1 nm. Pore or channel diameter can be determined by field emission scanning electron microscope (SEM) examination. As discussed in greater detail herein, in at least some instances the pore or channel diameter is larger than that thought necessary to create three points of contact with a chiral molecule. The larger chiral volumes provide greater sorting capacity of a chiral sample, and a more general sorting of chiral molecules, that is, a wide range of molecules of the same chiral orientation may be sorted using the chirally selective material according to one or more embodiments.

In one or more embodiments, the precursor polymer includes chiral monomers, typically at least about 30% monomers of the same chiral orientation. In some instances, the precursor polymer is a protein capable of forming an extended helical structure and producing a network of chiral layered phases. The amino acid sequence of the protein affects the pore size and channel diameter of the resultant gel, with pore and channel diameters commonly being nanoscale, e.g., ranging from a few nanometers to submicron dimensions, and typically less than 100 nm. In certain embodiments, the gel includes a fibrous protein having a liquid crystalline order and a nanoscale multilayered structure. Each layer includes a molecularly oriented fibrous protein, and the layers define an interlayer region having nanoscale chiral pores or channels. In some embodiments, the material is crosslinked. In certain embodiments, the crosslinks are physical crosslinks, consisting of β-sheet crystals several times smaller than the pore or channel diameter, embedded in the walls of the pores or channels. In some embodiments, the crosslinks are sets of hydrogen bonds or salt bridges between the molecules making up the material. In some embodiments, the crosslinks are made up of multifunctional molecules that react with several sites on the surface of the channel wall or pore surface.

In some instances, the precursor polymer is capable of forming chiral hexatic or chiral smectic phases. While not to be bound by any particular theory, the chiral hexatic or chiral smectic phases in a chiral gel formed from such a polymer may contain layers of molecules that attempt to twist. More specifically, due to the chirality of the polymer molecules, molecules within the layers may twist chirally in a manner that is not compatible with long range order in distinct layers, resulting in a network structure of twisted polymer layers and solvent-filled chiral pores or channels. Chirality disrupts the smectic liquid crystalline ordering, resulting in a patterned material with hierarchical order.

In one or more embodiments, the materials have a high internal surface area consisting of chiral pores or channels. Within a chiral channel or set of chiral interconnected pores, molecules transported through the channel, through convection, capillarity, diffusion or another mechanism, will interact frequently with the walls of the channel or interconnected system of pores. If the diameter of the channel or interconnected system of pores is similar to the molecule (1x-2x), the interactions between the molecule and the solid walls hinder certain aspects of the molecule's motion, and effectively hinder diffusion of the molecule or exclude it from the pores or channels. If the channel diameter or pore diameter is much larger than the molecule (>50x-100x) the chemistry and shape of the walls make a very minor contribution to the transport of molecules within the pore system or channels. However, for pores or channels with a diameter a few times to roughly an order of magnitude larger than a molecule (4x-60x), there typically is significant interaction between the molecule and the walls of the channel or pore, without significant barriers to diffusion. In this range of pore and channel sizes (i.e., diameters), a great deal of chiral interaction occurs between a solute and any chiral molecules, voids or structures within the surface of the material for every few Angstroms of diffusion. Furthermore, the curvature of the pore or channel walls and the chiral aspects of that curvature are at a length scale where physical interactions between the analyte and the wall involving, for example, transfer of angular momentum, configurational entropy of the analyte near the wall, and other similar interactions, become meaningful and significantly different for molecules with differing chiral symmetry.

The separation properties of chiral materials according to one or more embodiments are derived from the material structure, morphology and orientation rather than directly from the chemical composition of the molecules. In at least some instances, the chiral material has properties not found in substances naturally formed from the component molecules.

Mechanism of Chiral Separation

Chirally selective materials made as described herein are suitable for use as chiral selectors in wet or dried form. Materials made according to one or more embodiments provide a general mechanism for chiral separation that is independent of the chemistry of the enantiomers being separated (aside from typical separations physical chemistry factors, such as solvent wetting and solute partitioning). Typically conventional chiral materials are applicable to only a limited range of analytes because they rely on a chiral surface, cavity or volume of a similar size-scale to the molecules being selected, as well as close contact and specific interaction between the chiral molecule and the selector matrix at multiple contact points, to effect separation. In contrast, chiral selectivity is observed in the chirally selective materials according to one or more embodiments even in the absence of a ligand interaction, other binding interaction, or even a chemical affinity for the material containing the chiral pores or channels.

In certain embodiments, materials made as described herein are modified through chemical functionalization, for example, to alter the surface properties of the chiral material. In at least some instances, the materials retain their chiral selectivity even when functionalized with non-chiral moieties, again demonstrating that the chiral selection mechanism is based on the material structure, rather than typical chemical/molecular level interactions. Chemical interactions based on the added non-chiral moieties act in addition to the chiral selection mechanism.

While not to be bound by any particular theory, materials produced according to one or more embodiments herein may perform chiral separation via a chiral exclusion mechanism, in which molecules of a selected chiral orientation are excluded from the internal chiral volumes of the chirally selective material. Chiral sorting is driven by entropy and selective diffusion into and through interconnected pores and channels of the chiral material. In at least some embodiments, the microstructure of the gel (and dried resins or membranes and powders produced from the gel) provides a high surface area, controlled size distribution of materials features, and high interconnectivity of pores and channels to facilitate diffusion. The shape of the material's microstructure and nanostructure, defined at the supermolecular level, allows one enantiomer to enter more easily and spend a longer time in the pores and channels compared to the corresponding enantiomer of opposite handedness. One enantiomer is thus preferentially retained in the chiral pores or channels, while the enantiomer of opposite handedness passes through the material more quickly. In at least some instances, the chiral pores or channels are well-defined and the material lacks significant free volume accessible by non-chiral molecules, thereby improving selectivity. The tendency of the chirally selective materials to exhibit chiral exclusion may be exploited in column chromatography, extraction and filtration processes.

An exact or tight fit is not required between the shape and size of enantiomers of molecules to be separated, and that of the chiral pores or channels in the separating material. Rather, the chiral pores or channels of the separating material may be somewhat larger than the enantiomers to be separated. Even without a very close match of shape and size, molecules having the same chirality as the pores or channels preferentially explore the pores or channels, and statistically take longer to pass through the separating material than molecules having the opposite chirality. However, the chiral pores or channels are not so large that any sense of chirality is lost to the chiral molecules passing through. In certain embodiments, chiral pores or channels having a diameter less than about 50 times the size of the chiral molecules to be separated are utilized. For example, the pore or channel diameter is less than about 40 times, about 30 times, about 20 times, about 10 times, or about 5 times the size of the chiral molecules to be separated. Such chiral pores or channels having a volume of sufficient size to interact with chiral molecules, allowing separation of one enantiomer from another, are referred to herein as a “chiral volume.” In certain embodiments, the pores or channels have diameters between about 4 and about 60 times, for example, between about 20 and about 50 times the size of a chiral molecule to be separated. In some embodiments, the diameter of the chiral pores or channels is between about 5 nm and about 50 nm, for example, between about 5 nm and about 30 nm, whereas many enantiomers to be separated are smaller than about 1 nm.

Preparation of Raw Materials

In certain embodiments, methods of making chirally selective materials include preparing a polymer raw material, generating a sol from the raw material, dialyzing the sol, forming a gel from the sol, and washing, drying and/or grinding the resultant gel. Advantageously, the gel formation step in this process does not require templating, but instead employs a crystallization inhibiting additive that allows for gel formation, for example, by interfering with β-sheet formation in a protein solution. In at least some instances, temperature is used to trigger gel formation.

In at least some embodiments, chiral materials as described herein are made from polymers having a sufficient quantity of chiral subunits or monomers, enriched for one enantiomer, that they will form a chiral secondary structure (e.g., a helix) in the crystalline phase, will interact with other chiral phases in solution, and will have sufficient orientation to form chiral domains. In certain embodiments, the polymer includes at least about 30%, for example, at least about 40%, at least about 50%, at least about 60%, at least about 70%, or substantially 100% chiral monomers of a single orientation.

Suitable raw materials for making chiral gels (and resultant chiral solids) include without limitation natural fibrous proteins, proteins and polypeptides derived from such proteins, and biosynthetic materials having sequences derived from such proteins. Suitable fibrous proteins include, but are not limited to, collagens, keratins, chorions, actins, fibrinogens, fibronectins and silks, as described in more detail below. Other biological polymers, such as sugars, cellulose derivatives and other helical or simple chiral rigid molecular structures also are expected to form interpenetrating chiral layered phases, giving rise to chiral channels. Further useful raw materials include synthetic polypeptides and peptides with patterns of amino acids as described in W003/056297, entitled “Self-Assembling Polymers, and Materials Fabricated Therefrom,” which is incorporated herein by reference.

In some embodiments, raw materials include the general class of “elastomeric proteins.” These proteins occur in muscles, connective tissues and blood vessels of vertebrates, in bivalve mollusks as attachment proteins, in spider and insect silks, and in wheat seeds. They exhibit a number of common features, such as regular structures (e.g., dominant secondary structure motifs, supermolecular helical arrangements of secondary structures, molecules, or fibers in a tissue, extracellular material, extra-organism material, or intracellular structural material). Non-limiting examples of useful raw materials include the fibrous proteins collagens, FACIT collagens, mammal collagens, invertebrate collagens, sea sponge collagen, sea cucumber collagen, elastin, resilin and keratins. Synthetic molecules incorporating such fibrous protein sequences and patterns are also useful.

Isolation and processing of some fibrous proteins is facilitated because they occur as extracellular matrix proteins, or even are found outside of organisms, for example, invertebrates. Non-limiting examples of suitable extracellular proteins include silk, collagen, resilin, keratin and elastin. In certain embodiments, in addition to proteins such as collagens, elastins, and resilins extracted from invertebrates, extracellular proteins such as silks are obtained from, for example, cocoons, egg casings, dragline, or webs. Examples of natural silk types include without limitation spider dragline silks, spider capture silks, spider cribbelate silks, spider anchor silks, spider web silks, insect cocoon silks, and insect and spider egg casing silks. Major silk producing organisms include spiders, embiids (embiidina), larvae of moths and butterflies (Hymenoptera and Lepidoptera), flies, bees, and wasps.

In some embodiments, various silks, collagens, and other fibrous proteins from the nine orders of Arachnida are used. Non-limiting examples of Arachnida that possess multiple forms of silk obtainable in useful quantities include the following: jumping spiders (family Salticidae, sometimes called salticids), crab spiders (e.g., Misumenoides), golden silk spider (Nephila clavipes), spiny orb-weaver (Gasteracantha cancriformis), argiope spiders (e.g., Argiope aurantia), green lynx spider (Peucetia viridans), wolf spiders (family Lycosidae, e.g., Lycosa carolinensis), long-jawed orb-weavers (genus Tetragnatha).

Further non-limiting examples of silk-producing genera, families, and specific organisms include the following: Aranea, Nephila, Antherea, Bombyx, Argemia, Gonometa, Borocera, Anaphe, Tetragnathidae, Agelenidae, Pholcidae, Theridiidae, Deinopidae, Meteorinae (Hymenoptera, Braconidae), Embiidina, Tropical Tarsar Silkworm Anthereae, Eri Silkworm, Samia recini, Philosamia ricini, Antheraea assama, Nang-Lai, Satumiidae, Antheraea periya, B. mandarina, Antheraea mylitta (Doory), Antheraea Asamensis Helfer, cocoons of the parasitic wasp Cotesia (Apanteles) glomerata, Antheraea yamamai, Callosamia (Saturniidae), Hemileuca grotei (Satumiidae), Anisota (Saturniidae), Schinia, Hemileuca (Lepidoptera, Saturniidae), genera Actias, Citheronia (Saturniidae) and subfamily Euteliinae (Noctuidae), Hemileuca maia complex (Satumiidae), Arsenurinae (Saturniidae), Agapema (Lepidoptera, Saturniidae), Attacus mcmulleni (Satumiidae), Lasiocampidae (Lepidoptera), Attacus Caesar, Anisota leucostygma, Cricula trifenestrata, Natronomonas pharaonis, Sphingicampa Montana, Pygarctia roseicapitis, Leucanopsis lurida, Hemileuca hualapai, Hemihyalea edwardsi, Grammia geneura, Eupackardia calleta (wild silkmoth), Automeris patagoniensis, Automeris cecrops pamina, and Antherea oculea.

The polymer raw materials are prepared for making the chiral material. In certain embodiments, raw materials containing a natural protein are washed. For example, cocoons are washed to remove sericin and obtain clean silk fiber. In some embodiments, cocoons are separated from debris (e.g., bugs, dirt, twigs) and washed with water containing Na₂CO₃. In some instances, soap is also used. For example, the cocoons are immersed in water and heated. In some instances, heating is performed for between about 20 minutes and about 1 hour, for example, about 25 minutes or about 45 minutes. In certain embodiments, Na₂CO₃ is present at a concentration between about 0.01 M and about 0.05 M, for example, between about 0.02 M and about 0.03 M. The cocoons are then rinsed to remove sericin. In certain embodiments, the cocoons are rinsed with water until the pH reaches about 7.0. In some embodiments, the rinsed cocoons are then dried, e.g., by spinning and/or drying in a hood.

In some alternative embodiments, washing is performed using other salts and/or surfactants. For example, in some instances NaCO₂ and sodium dodecyl sulfate dissolved in hot water are employed. The addition of sodium dodecyl sulfate or another moderate molecular weight surfactant improves the cleaning power of the water, reducing the time that the raw material is exposed to hot water, and thus limiting thermal degradation. Further non-limiting examples of useful salts and surfactants include quaternary ammonium salts and sodium laureth sulfate. In certain embodiments, washing is performed using a solvent applicable for a specific raw material. For example, solvents for sericin such as dimethyl sulfoxide (DMSO)/LiCl and other organic solvents and salts are useful for washing cocoons to obtain clean silk fiber.

Sol Formation

A sol is generated from a polymer solution of the raw material. In one or more embodiments, the sol is formed when colloidal order is established and/or the polymer adopts a folded state. A sol may be viewed as the solution state precursor to a gel. In at least some instances, the sol is obtained by cooling a polymer solution from an elevated temperature to a lower temperature. For example, the sol may be a viscous liquid in a lyotropic liquid crystalline phase that is obtained by cooling an isotropic liquid solution. The sol may be a viscous liquid that is a stable colloidal dispersion obtained by evaporating the solvent medium. In some instances, micelles may form as the liquid solution passes through a critical micellar concentration. The sol may be a viscous liquid in which the motion of polymer chains is impeded due to interactions between the chains, such as folding.

In at least some embodiments, the polymer is dissolved in an interactive solvent, i.e., a solvent or solvent system strong enough to maintain separation and distinctness between the polymeric molecules in solution, but not so strong that secondary and supersecondary structures are lost completely. For example, in some embodiments, in the case of silk, the specific secondary structure is slightly altered, but some of the supersecondary folded structure is retained. While not to be bound by any particular theory, the interactive solvent may help prevent pinning interactions, such as the formation of physical or chemical crosslinks among polymer chains (e.g., β-sheet formation in a protein) or reaction within polymer chains in solution. The polymer molecules typically are solvated and not merely swollen in the interactive solvent. In certain embodiments, the interactive solvent includes a protic solvent or polar solvent capable of forming hydrogen bonds, e.g., water, or a solution of a strong salt

In at least some embodiments, the interactive solvent is a good solvent (as understood by those skilled in the art of polymer science), but not denaturing. Liquid solvents for polymers include “good” and “poor” solvents. The solvent quality is directly related to the ability of the solvent molecules to balance pairwise attractive and repulsive interactions between monomers and mediate the attractive intrachain forces responsible for the polymer-solvent demixing. A “good” solvent will promote polymer-solvent miscibility. “Good” solvents include structured polar solvents, e.g., water, or a solution of a strong salt.

In some embodiments, the dried or undried raw material (e.g., cleaned silk fiber or other fibrous protein) is dissolved in a salt solution. In certain embodiments, a protein solution is formed with a concentration of protein solids of at least about 3% by weight, for example, between about 3% and about 20%, between about 5% and about 15%, between about 8% and about 12%, or about 10%. In some embodiments, protein concentrations in excess of about 20% are employed. In contrast, templating processes for making chiral materials typically are carried out with a protein concentration no more than about 5% to about 8% by weight, due to the difficulty of templating more concentrated protein solutions. In general, a higher solution concentration typically improves the chiral selectivity of the final material made.

In some embodiments, a salt solution of the polymer is made using a lithium salt such as LiBr or LiSCN. In some instances, LiSCN is used to form a protein solution, e.g., a high quality silk fibroin solution with concentration up to about 5% by weight of silk fibroin in water. Further non-limiting examples of useful solubilizing agents include ionic liquids or liquid salts, sodium salts (e.g., sodium chloride, sodium fluoride, sodium carbonate), potassium salts, calcium salts, lithium salts, magnesium salts, manganese salts, and combinations of lithium salts and divalent salts (e.g., Mg or Ca carbonates, sulfates, or chlorides). Because divalent salts are present throughout the silk spinning process, in embodiments employing silk these salts may enhance protein solubility while preserving features of the protein molecular structure. In certain embodiments, ionic liquids are used in addition to divalent salts to aid in breaking down hydrogen bonds within β-sheets of fibroin, without breaking down the protein backbone.

In certain embodiments, the salt concentration is between about 1 M and about 12 M, for example between about 5 M and about 11 M, or between about 8 M and about 10 M. In some instances, dissolution is achieved upon heating the raw material in the salt solution, for example, to a temperature between about 40° C. and about 120° C., between about 50° C. and about 90° C., between about 60° C. and about 80° C., between about 65° C. and about 75° C., or between about 90° C. and about 110° C. In some embodiments, heat is applied for about 20 minutes to about 3 hours, for about 45 minutes to about 2 hours, for about 30 minutes, for about 45 minutes, or for about 60 minutes. In certain embodiments, multiple heating steps are used (e.g., about one hour at about 75° C. followed by about one hour at about 90° C.). As the solution cools to ambient temperature (e.g., about 24° C. to about 28° C.), a viscous sol forms.

In some embodiments, as described in more detail below, dialysis is used to concentrate a dilute solution. Silks, and many other fibrous proteins, are sensitive to chemical interfaces when dissolved in aqueous solution. Accordingly, in at least some embodiments, slow (diffusion limited) introduction and removal of solvent and packaging of the solution to limit contact with hydrophobic surfaces or air are employed to help prevent the protein molecule from undergoing irreversible changes in structure during solution processing.

Dialysis of the Sol

In some embodiments, the sol obtained as described above is dialyzed. Dialysis helps to removes the salt, e.g., LiBr. In some instances, dialysis is performed to remove at least about 40%, at least about 50%, or at least about 60% of the salt. In at least some embodiments, dialysis is performed against water. For example, in some instances the sol is placed into dialysis tubing, which is then sealed. The filled dialysis tubing is immersed in water (e.g., at pH 7.0) for a time period between about 6 hours and about 72 hours, for example, between about 18 hours and about 48 hours, for example, about 24 hours. In some instances, a hose is connected to run water continually into the dialysis pan from the bottom. Runoff from overflow is useful to promote good circulation. In at least some embodiments, another round of dialysis is performed by transferring the sol from the original dialysis tubing into new dialysis tubing, which is then sealed. In certain embodiments, if excessive fine particulate matter is present in the sol, it is filtered to remove the particulates before being placed in the new dialysis tubing.

In certain embodiments, the new dialysis tubing is immersed in deionized water (e.g., pH 7.0) for a time period between about 2 hours and about 120 hours, for example, between about 4 hours and about 6 hours, between about 6 hours and about 24 hours, between about 18 hours and about 48 hours, between about 36 hours and about 64 hours, between about 56 hours and about 84 hours, between about 72 hours and about 120 hours, about 96 hours, or about 120 hours. In some embodiments, shorter dialysis times (e.g., between about 4 hours and about 6 hours) are used, and the temperature is ramped up, for example, from about 36° C. to about 60° C. In other embodiments, longer dialysis times (e.g., about 96 hours to about 120 hours) are used at about room temperature.

Following dialysis, conductivity of the Sol is measured. Conductivity can be used as an indication of salt content. Tap water (when dialyzing against tap water) and deionized or distilled water (when dialyzing against deionized or distilled water) are used as controls. In one or more embodiments, the conductivity of the sol inside the dialysis membrane after dialysis is within about 10% of the conductivity measured for fresh water outside the membrane before dialysis makes the water salty. For example, in some embodiments, if the sol conductivity is greater than the typical conductivity of deionized water, the deionized water dialysis cycle is repeated until the sol conductivity reaches the typical conductivity of deionized water. The sol typically is then filtered, e.g., using a sieve.

In some embodiments, prior to dialysis against pure water, dialysis is first performed against a divalent salt to stabilize the protein molecular structure in aqueous solution. While not to be bound by any particular theory, gradually stepping down the concentration of salt in the water solution used for dialysis may provide for the creation of fewer pockets of different chemistry (microscopic interfaces at the edges of the polymer solution), thus providing for a more stable process and higher quality polymer solutions.

In certain embodiments, a sol is concentrated, for example, by dialysis against water, a polyelectrolyte (e.g., poly[vinyl alcohol] or poly[ethylene glycol]) or a salt solution. In particular embodiments, dialysis against an ionized plasticizing low molecular weight polymer (e.g., a polypeptide or nylon) is used to concentrate the polymer solution while also introducing new mechanical and physical properties. Alternatively, in some instances concentration is performed using a weakly hydrophobic high molecular weight liquid as a moisture barrier. For example, a natural hydrogenated or unhydrogenated oil, hydrophilic polymer with high enough molecular weight to have poor solubility in water, or high molecular weight sugar or saccharide compound is used to provide a barrier layer over a polymer solution that allows slow diffusion of water out of the solution (through the moisture barrier material). In various embodiments, any concentration or dilution technique that does not “shock” the polymer solution can be used to control concentration.

Formation of a Gel

In one or more embodiments, a gel is formed by contacting the polymer sol with an additive that promotes gel formation. In at least some embodiments, the additive serves as a crystallization inhibitor. In at least some instances, the additive ionizes readily. In certain embodiments, the additive is acidic or basic. In some embodiments, high concentrations of salt are used. In at least some instances, temperature is used to trigger gel formation in the presence of the additive. While not to be bound by any particular theory, the additive may interfere with β-sheet formation in a protein (the natural form of the protein), thereby allowing a gel to form. It is believed that the ions of the additive in solution interfere with hydrogen bonding that would otherwise cause protein β-sheet formation. The additive may also enhance the solubility of the polymer.

In certain embodiments, the polymer solution or sol used to form the gel has a concentration of polymer solids of at least about 3% by weight, for example, between about 3% and about 20%, between about 5% and about 15%, between about 8% and about 12%, or about 10%. In various embodiments, between about 0.05 wt % and about 10 wt % acid or base is added to the sol (wt % in this instance refers to the weight ratio of acid or base to polymer solids) to promote gel formation. Examples of suitable acids include, but are not limited to, hydrochloric acid, acetic acid, nitric acid, phosphoric acid, carbonic acid, formic acid, propionic acid, sulfuric acid, trifluoroacetic acid, and Lewis acids, such as, for example, AlCl₃ and FeCl₃. Examples of suitable bases include, but are not limited to, NaOH, phosphate salts, and calcium carbonate.

In some embodiments, the sol is incubated with the gel-promoting additive for about ½ hour to about 48 hours, for about 12 hours to about 36 hours, or for about 24 hours. In at least some instances, incubation is performed in a sealed container. In certain embodiments, incubation is performed at a temperature between about 15° C. and about 50° C., for example, between about 25° C. and about 40° C., between about 30° C. and about 35° C., or between about 40° C. and about 50° C. Upon incubation, a gel is formed. Gels formed at lower temperatures often are somewhat less structured.

In various embodiments, formation of the gel is carried out so as to obtain the desired gel shape or form factor. By way of non-limiting example, in certain embodiments, a bulk gel is formed in a container of the desired shape. In other embodiments, a gel is formed as a cast film or membrane on a substrate. In some embodiments, the gel is cast or molded as a monolithic block, and then cut or machined into the desired shape. In at least some instances, the gel provides a substantially homogeneous chiral structure. In one or more embodiments, the gel is a substantially rigid, self-supporting monolithic material that provides good strength and mechanical integrity. These properties are useful in various chiral separations applications such as membrane and filter systems.

In at least some embodiments, the gel is washed, for example, with water to remove the gel-promoting additive. The washing is performed when the gel is wet, or after drying. Rinsing the gel also helps to increase its chiral selectivity, for example, by removing impurities.

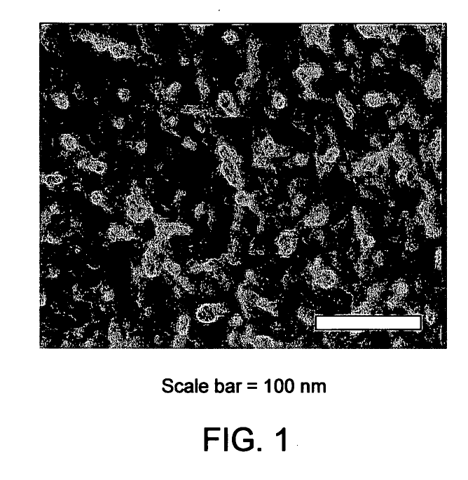

FIG. 1 shows a chiral material obtained using an additive and heat induced gelation. The gel was dried without collapsing its structure using supercritical fluid extraction. The structure is very regular, unlike ordinary foams and hydrogels. The fully expanded aerogel obtained in this manner has a “cell” size of about 30 nm, compared to about 11 nm in a dried collapsed material. In some embodiments, the degree of swelling or collapse in a gel is controlled by exchanging solvent prior to extraction, resulting in different pore or channel sizes.

In some embodiments, gel formation is carried out in the presence of a salt, e.g., without prior dialysis to reduce salt content of the precursor sol. Conditions allowing for formation of a gel in the presence of relatively high salt content in a protein sol include one or more of the following: relatively greater protein concentrations, relatively greater amounts of crystallization inhibitor, relatively longer gel times, and relatively higher temperatures compared to those typically employed when forming a gel from a dialyzed protein solution. By way of non-limiting example, in certain embodiments employing sols prepared from silk, in excess of about 20 wt % silk is used for gelling without prior dialysis, in contrast to about 3% to about 20% silk when forming gels from dialyzed solutions. Crystallization inhibitors typically are used at greater than about 5 wt % (weight ratio of crystallization inhibitor to polymer solids) for gelling without prior dialysis. In at least some embodiments where the sol is not dialyzed gelation is carried out at a temperature of about 30° C. to about 60° C., for example between about 30° C. and about 50° C. In at least some instances, gel formation is carried out for at least about 4 hours, as compared to shorter gel times that may be used in some cases for dialyzed sols. In certain embodiments, salt is later removed from the gel formed without prior dialysis, for example, during subsequent annealing and/or washing steps.

As noted above, the methods described herein allow for gel formation without a templating step (forming a gel at the interface between the sol and an immiscible liquid) that can be both cumbersome and labor-intensive. Templating also often employs toxic organic solvents in a constrained environment. By allowing for the elimination of toxic (or environmentally unfriendly) templating solvents, the methods described herein produce chirally selective materials that are fully biocompatible and pharmaceutically compatible even as wet membranes. Forming a gel without templating also avoids the core/skin or gradient structure that results from templating at an interface, and allows gels to be formed in a wide variety of shapes and formats, without being constrained by the shape of molds used to form templated interfaces. Furthermore, material formed by gelling as described in one or more embodiments herein may provide about five to about forty times better chiral selectivity compared to templated gels of similar composition, for example, providing a selectivity index (enantiomeric excess %) of about 45, compared to a selectivity index of about 10 for templated materials. Enantiomeric excess can be represented by the absolute value of the difference in moles of two enantiomers present in a sample divided by the total moles of both enantiomers in the sample, i.e., (|moles A−moles B|/(moles A+moles B))×100% for a sample containing enantiomers A and B. Gels formed by templating have chiral pores or channels with relatively flat curvatures. However, gels formed in bulk solution utilizing one or more additives as described herein have chiral pores or channels that are more highly curved. While not to be bound by any particular theory, such highly curved chiral pores or channels may be able to more efficiently “trap” certain enantiomers, thus providing more efficient chiral separation.

Annealing the Gel

In some embodiments, the gel is annealed using one or more solvents and/or temperature (e.g., between about 15° C. and about 70° C.). Annealing is optionally performed to stabilize the structure of the gel and/or increase chiral selectivity. In various embodiments, annealing is used to control the size, shape and/or number of chiral pores or channels, to reduce defects in the gel, to induce grain growth, to densify the gel structure, and/or to enhance operational properties of the gel. While not to be bound by any particular theory, a solvent annealing process may encourage the gel to rearrange its structure to enhance chiral selectivity. For example, sufficient kinetics and/or driving force may be provided to the gel to promote grain growth and/or refinement of chiral pores or channels. Furthermore, while β-sheet formation is typically reduced or avoided in the prior gel formation step, once the gel is formed, a small amount of β-sheet structure may be reintroduced into the material to strengthen and stabilize the chiral structure.

The annealing solvent may different than the solvent used in sol or gel formation. Suitable annealing solvents include, but are not limited to, water, alcohols (e.g., ethanol, methanol, 1-propanol, 2-propanol), amino alcohols, alkane solvents (e.g., hexane, pentane, heptane, octane), acetone, ether, chloroform, dioxane, tetrahydrofuran, citric acid, acetic acid, lactic acid, malic acid, aqueous sucrose, aqueous glucose, aqueous fructose, aqueous mannose, aqueous dextrose, acetonitrile, and other weakly solubilizing solvents. As a non-limiting example of annealing, in some embodiments a solvent more hydrophobic than water (e.g., alcohol, or a mixture of alcohol and water) is used to encourage densification and β-sheet formation that stabilizes a protein gel. In some instances, once the desired pore or channel size and structure has been obtained, supercritical fluid extraction or crosslinking is used to “freeze” the gel structure.

In certain embodiments, the gel is incubated in the annealing solvent, for example, in a sealed container. In some embodiments, the annealing solvent is rinsed off and the incubation container is refilled with annealing solvent and returned to the incubator. This solvent changing optionally is performed up to about five times. In some instances, annealing is performed at a temperature between about 15° C. and about 70° C., between about 30° C. and about 60° C., or between about 40° C. and about 55° C. In certain embodiments, annealing is carried out for at least about 1 hour, at least about 3 hours, about one day, about two days, or up to about 3 days.

Structural advantages obtained by annealing a gel as described above are broadly applicable to chiral gels including those described in WO 2004/041845, entitled “Templated Native Silk Smectic Gels,” and the U.S. patent application filed on even date herewith, entitled “Particulate Chiral Separation Material,” which claims priority to U.S. Provisional Application Nos. 60/751,545 and 60/785,669. All of these applications are incorporated by reference herein.

Physically Curing the Gel

In certain embodiments, a physical curing process is employed to stabilize nanoscale features of the gel, for example, by introducing physical (e.g., non-chemical) crosslinks, such as β-sheet crystalline nuclei or other domains locally within the gel structure. For example, in some embodiments, exposing a swollen protein gel to heat and/or alcohol (e.g., methanol, ethanol, or propanol) causes the proteins to rearrange and form β-sheets. In some embodiments, soaking a fully dried gel in an optionally heated water/alcohol solution effects physical crosslinking via β-sheet formation. The water swells the medium and allows the alcohol to penetrate into the interior. In some instances, about 50% to about 95% alcohol concentration is employed. While not to be bound by any particular theory, these physical crosslinks are expected to increase the chemical stability of the material to acids, bases, and other solvents, while also improving toughness and hardness.

Structural advantages obtained by physically curing a gel as described above are broadly applicable to chiral gels including those described in WO 2004/041845, entitled “Templated Native Silk Smectic Gels,” and the U.S. patent application filed on even date herewith, entitled “Particulate Chiral Separation Material,” which claims priority to U.S. Provisional Application Nos. 60/751,545 and 60/785,669, all of which are incorporated by reference herein.

Chemically Modifying the Gel

In certain embodiments, a chemical modification agent is added to change the surface chemistry of pores or channels of the gel. In certain embodiments, coatings, functionalization with polymers, and/or ligand or modifier additions are employed. By way of non-limiting example, in various embodiments chemical functionalization is used to introduce chemical compatibility with particular compounds, chemically or chirally selective ligands, particular adsorption properties, or mechanical, thermal or chemical stability, or to modify pore or channel structure or size. For example, in some instances chemical modification agents are used to make the material hydrophobic, to make the material attractive to halogen or sulfur, or to coat the material with a silane compound. Suitable chemical modification agents include, but are not limited to, silanizing agents, crosslinkers, hydrophobic coating agents, coupling agents and the like. In some instances, the chemical modification agent is added in the presence of an annealing liquid or other solvent in an incubator. In at least some embodiments, the gel is incubated with the chemical modification agent at a temperature that promotes reaction with the modification agent. Typically, the incubation temperature does not exceed about 70° C. Following incubation, in at least some embodiments, the gel is washed in water, alcohol or another solvent to remove excess chemical modification agent.

As a non-limiting example of chemical modification, in certain embodiments, chemical crosslinks are introduced to control chemical stability, chiral pore or channel size, and/or chirality of the material. In various embodiments, chemical crosslinking is performed on a gel that is partially or fully swollen, or fully dried. Alternatively, gel formation is carried out in the presence of a crosslinking agent, thus directly forming a crosslinked gel. In some instances, known methods for crosslinking proteins and polyamides are employed to introduce chemical crosslinks in a protein gel. For protein based chiral materials, reactive groups include OH, NH₂ and COOH. These groups allow for condensation polymerization and include formation of glycidyl ethers. For condensation, anhydrides, di-,tri-, and multifunctional-acids, di-, tri-, and multifunctional-amines, amino alcohols, di-ols, glycols, di-, tri- and multifunctional glycidyl ethers, di-, tri-, and polyfunctional epoxides and sulfoxides, and molecules having combinations of two or more reactive functional groups are all useful crosslinking agents. Crosslinking is not limited to di-functional groups; tri- and tetra- functional crosslinking agents are used as well. The higher number of potential crosslinking groups, the higher the crosslink density, which may impart areas of “hardness” relative to other areas. Within a multi-functional crosslinking agent, the bridge between the active moieties can be different. In some instances, a non-symmetrical linking agent is employed (for example, a glycidyl ether on one end and an acrylate on the other, or a monoacrylate with a functional group that can condense on the other). Using a non-symmetric material with an acrylate allows for addition polymerization. In some embodiments, groups are attached to the molecules that do not participate in crosslinking reactions, but that do alter the surface chemistry of the chiral material. For example, a molecule with di-, tri-, or polyfunctional glycidyl ether functionality can also have alkane sequences connecting the crosslinking diglycidyl ether functions, which impart hydrophobic alkene character to the chiral materials surface once the molecule is crosslinked onto the surface. Similarly, a pendant alkane or other functionality, present as a side chain or side group and not attached at both ends to atoms bonded to the crosslinking groups, can be used to impart hydrophobic C8, C18, or other typical “reversed phase” HPLC chemistries to the surface of the chiral materials. In certain embodiments, glutaraldehyde curing is employed. A combination of mild acidic and mild basic conditions are used to attach glutaraldehyde to protein sites to form crosslinking covalent bridges between molecules. In other embodiments, crosslinking is performed using agents such as, for example, poly (propylene glycol) diglycidyl ether (PGDE) or citric acid. In some embodiments, inorganic crosslinking agents are used, such as boric acid, phosphorous containing compounds and sulfur compounds.

While not to be bound by any particular theory, for a dried medium with chiral pore size and channel diameter of several nanometers, the crosslinks are not expected to span the diameter of the channel, such that crosslinking likely is limited to the channel walls. Furthermore, in a hydrated state the gel tends to be highly ordered, making random crosslinks (as in a traditional hydrogel or rubber) unlikely. In some embodiments, a swollen protein gel appears to be in a lamellar (chiral interpenetrating) liquid crystalline phase, with high concentrations of protein in the lamellar layers, separated by several nanometers of solvent. In the swollen state, glutaraldehyde or other chemical covalent crosslinks likely will act in the protein rich layers. This is expected to change the mechanical properties of the layers and reduce any structural tendency to collapse upon drying, locking in a larger pore or channel size and more easily hydrated structure.

In at least some instances, chemical crosslinks increase the chemical stability range of the gel. For example, materials produced as described in one or more embodiments swell in water, but are capable of retaining adsorbed enantiomers when swollen even for hours or days. Retention of enantiomers in water-based solutions is advantageous, particularly when the inner surface of the chiral material is designed to have acidic, basic and/or hydrophobic functionality. In an aqueous environment, these chemistries are available to draw in and hold enantiomers. For example, larger capacities are observed for charged enantiomers inside oppositely charged materials when water is used as a solvent or cosolvent.

In some embodiments, the interior volumes of a chiral material are coated with a substance that promotes favorable interactions with particular types of chiral molecules to be separated.

Structural advantages obtained by chemically modifying a gel as described above are broadly applicable to chiral gels including those described in WO 2004/041845, entitled “Templated Native Silk Smectic Gels,” and the U.S. patent application filed on even date herewith, entitled “Particulate Chiral Separation Material,” which claims priority to U.S. Provisional Application Nos. 60/751,545 and 60/785,669, all of which are incorporated by reference herein.

Additional Post-Gel Processing

In some embodiments, the gel formed from the sol as described above (and optionally annealed and/or chemically modified) is recovered and transferred to a solvent for storage in a sealed container. For example, in some instances gels to be used as filters or membranes are stored in a solvent. Alternatively, the recovered gel is dried or freeze-dried. In certain embodiments, drying is performed at room temperature for one or more days, for example, for about 48 hours in a location with good air circulation. The dried gel is also referred to as a resin. In some instances, the resin is ground to form particles.

In some embodiments, a resin (dried gel) formed as described according to one or more embodiments is used directly in various chiral separation applications. Alternatively, the resin is ground to form a powder, e.g., for use in chromatography. In some instances, the ground particles are sorted by size using a sonic sifter or other standard size sorting apparatus. By way of non-limiting example, in certain embodiments the resin is ground to a particle size of about 355 μm, about 250 μm or less, about 150 μm or less, about 100 μm or less, about 50 μm or less, or about 25 μm or less, using, e.g., a standard test sieve to verify particle size.

In certain embodiments, the ground resin is washed. For example, in some instances the resin is mixed with water at room temperature until conductivity ceases to change (e.g., about one hour), and allowed to stand unstirred so the resin settles (e.g., for about one hour). The conductivity of the water above the settled resin is measured and the water is filtered off. In some instances, these water washing steps are repeated until the conductivity of the water above the settled resin is no higher than about 600 mHo (±30 mHo). In at least some embodiments, additional washing is then performed with deionized water (conductivity about 25 mHo to about 50 mHo), and repeated until the deionized water conductivity returns to about 25 mHo to about 50 mHo. In certain embodiments, the resin is then washed again in another solvent, for example, 2-propanol. In at least some embodiments, the resin is filtered and dried following washing. In some instances, drying is performed at ambient temperature for about 12 hours to about 24 hours. In certain embodiments, the resin is further dried under vacuum, in some instances at elevated temperature (e.g., at about 55° C. for about one hour). In some instances further drying is performed in desiccator cabinets. The dried particles are then suitable for sieving (e.g., using a standard test sieve) and storage.

Applications

Chirally selective materials made by the methods described herein are useful in a variety of applications, including but not limited to membranes, filters, sorbents, and chromatography media for performing chiral separations. The chiral material can be provided in a variety of forms suitable for use in various applications. For example, in one or more embodiments, the chiral material is provided in a monolithic form that affords good mechanical stability and is useful, for example, in chiral membranes, filters, and monolithic materials to fill chromatography columns. In some embodiments, the pore or channel size and chemical functionalization of the material are controlled as described above, for example, to adjust the selectivity and capacity of the material, improve interaction with certain chemical classes, and/or allow for multiple chiral separations.

In some embodiments, a chirally selective material in the form of a gel or dried gel (resin) is used as a filter or membrane that allows only one enantiomer of a chiral molecule to pass through, while retaining the other enantiomer. In various embodiments, membranes or filters are used for one-pass separations, or are constructed as multistage membranes or filters. A preformed cast or molded article of chirally selective material having a substantially homogeneous chiral structure, produced according to one or more embodiments, provides a useful monolithic form having sufficiently high chiral selectivity to perform well in such filtration applications.

Advantageously, the methods described herein allow for production of the chirally selective material in various shapes and sizes for use as a filter or membrane. By way of non-limiting example, the material is produced in the form of a thin film, a layer, a conformal coating, a tube, or a cylinder. In some instances, the desired form is produced by casting a sol into a container having the desired shape, or casting the sol onto a surface in the case of a coating, and allowing the gel to form in the desired format. Alternatively, the gel is formed as a monolithic block, and then cut or machined into the desired shape. In certain embodiments, swollen hydrogels from which solvent has been supercritically extracted are used to provide soft membranes and filters suitable for use, for example, in solid phase extraction and lower pressure applications. Membranes can be formed in various shapes to provide continuous belts, blades, swizzle sticks, cuvettes, and other parts made from chirally selective material.

In some embodiments, a gel formed according to one or more embodiments is used as a chiral sorbent. A mixture of enantiomers to be separated is combined with the chirally selective material in a solvent. One enantiomer preferentially enters the chirally selective material, while another enantiomer remains in the bulk solvent. The solvent is filtered off, leaving the chirally selective material containing one enantiomer. The process is repeated until the desired degree of separation is obtained. For example, in some embodiments, about 5 to about 50 stages (i.e., repetitions of contacting the chirally selective material with the mixture to be separated) are used to provide a separation that is at least about 90% selective. In comparison, existing technologies require about 1,000 stages to provide comparable selectivity. Following separation, the enantiomer that is not retained by the chirally selective material is obtained from the bulk solvent. Typically, the enantiomer retained in the chirally selective material is contained within the material, but is not bound to the material. In some embodiments, the retained enantiomer is released by immersing the chirally selective material in a solvent that extracts the retained enantiomer, determined experimentally. This chiral sorbent approach is useful for performing separations on the gram or kilogram scale. Chirally selective materials made according to one or more embodiments herein provide high performance sorbents with high selectivity and capacity.

In certain embodiments, a chirally selective gel is dried into a resin and then ground into a powder for use as a chiral sorbent. In some applications, the chiral sorbent is combined with a binder or matrix material to provide a sorbent-embedded surface. In certain embodiments, the sorbent has a particle size between about 100 nm and about 5 microns, for example, between about 150 nm and about 800 nm, between about 300 nm and about 1 micron, or between about 500 nm and about 2 microns. Larger particles often are useful when the chiral material has a high affinity for one enantiomer in a racemate. For example, this allows the chiral separation to be performed with stirring in a vessel, and the sorbent particles subsequently filtered off.

Materials made as described in one or more embodiments herein also are useful in various chromatography applications, including low to moderate pressure (e.g., about 100 psi to about 200 psi) liquid chromatography (LC), flash LC, affinity LC, and HPLC. Supercritical fluid separations also are made possible. In certain embodiments, the chirally selective material in the form of a resin is ground and packed into a chromatography column. Particle size typically is selected based on the application. For example, in some cases particles between about 10 microns and about 150 microns are used for low pressure LC applications, and in some instances particles between about 1 micron and about 10 microns are used in supercritical fluid applications. In one or more embodiments, the material provides chiral selectivity sufficient for analytical chromatography and quality control applications. For example, in some embodiments, scaled up separation is achieved in about 10 to about 20 sorbent stages of LC. In various embodiments, the chromatography columns are operated in isocratic, gradient, reverse phase, or ion-affinity mode. The columns are suitable for use with aqueous and non-aqueous solvents.

The chromatographic systems are adjustable to cause either enantiomer of a chiral compound to elute first, depending on the solvent system used as a mobile phase in the separation. Solvents that swell the material often reverse the elution order compared to solvents that do not swell the material. Strong polar and electrostatic chemical interactions are effectively screened in non-swelling solvents, allowing the shape interaction to dominate chiral selectivity. In contrast, shape interaction is weakened in swelling solvents, where polar, electrostatic and H-bonding interactions are stronger and tend to dominate. Solvent-based elution order reversal is possible because of the generality of the chiral selection mechanism(s) provided by the material.

Since chiral separation can be obtained across a range of solvents and solvent systems, varying the solvent composition provides a rich landscape of chirally selective behaviors. In addition to standard chiral separations, the systems are suitable for carrying out chemical separations, separation of achiral stereoisomers, and multi-component separations, including simultaneous resolution of multiple chiral isomers and their enantiomers and/or achiral stereoisomers and/or chemically closely related species. In certain embodiments, the columns are used to simultaneously separate several different compounds, each of which is present as a mixture of isomers. Each enantiomer and/or stereoisomer of each compound elutes separately. Typically, the isomers of one compound elute separately, followed by separate elution of the isomers of another compound. Chromatographic separations using the chirally selective materials made as described in one or more embodiments herein generally are performed with an analyte on the gram or milligram scale.

In some embodiments, rather than (or in addition to) adjusting the solvent system, the chiral material itself is chemically functionalized to accommodate various modes of separation and/or improve interaction with particular chiral molecules to be separated. Examples of chemical functionalization are described above. For example, in at least some instances the chiral material includes ionic groups. Accordingly, when it is desired to perform a separation under non-ionic conditions, either the ionic groups are reacted off of the surface of the chiral material, or the material is used under solvent conditions that do not support ionization.

In some embodiments, the chirally selective material is dried into a resin and then ground into a powder for use in an HPLC column. In certain embodiments, the powder has a broad distribution of particle sizes of about 25 μm or less, about 50 μm or less, about 100 μm or less, or about 150 μm or less. The solvent system for HPLC is chosen based on the analyte, according to standard methods known to those skilled in the art. In some instances, larger particles (e.g., about 150 μm or less) are used in aqueous media. In certain embodiments, the chiral material swells when significant amounts of water are part of the mobile phase. In some cases, when columns are to be used with aqueous solvents, particles of chirally selective medium are pre-swollen in water. Larger particles have more room around them to swell, and create an effective monolith when swollen inside the column. In some instances, the material is crosslinked prior to packing to promote water stability. In some instances, the material is coated with a hydrophobic layer (e.g., silane coupling agents such as hexamethyldisilane (HMDS)) to provide stability against swelling by water and to promote hydrophobic reverse phase interactions.

In some embodiments, an HPLC column is packed with particles of chirally selective medium that are between about 5 μm and about 25 μm, or particles that are about 25 μm or smaller (no fine particle cut-off), or particles that are between about 25 μm and about 100 μm. By way of non-limiting example, in certain embodiments, a column is packed as follows. The chirally selective material is slurried using isopropanol and/or hexane. The slurry is pumped into a column, or into a precolumn reservoir, which is then connected to an empty column casing. In some embodiments, the column is between about 2.5 cm and about 25 cm long, and between about 0.5 mm and about 2 cm in diameter (inner diameter). If an air gap results on packing the column, in some instances it is left (e.g., for use in water-based systems), and in other cases it is filled with additional chirally selective material to achieve a tight packing (e.g., for use in non-water-based systems). Once the column is full, it is sealed for use, e.g., in normal phase HPLC. In certain embodiments, chirally selective media from used columns is regenerated by swelling, washing and then de-swelling it for reuse.

HPLC columns made from chirally selective material made according to one or more embodiments herein provide excellent selectivity, purity, yield and throughput. The columns allow for separation of enantiomers and achiral stereoisomers of classes of compounds including, but not limited to, terpenes, free amines, free acids, alkaloids, chiral acids, chiral bases, organometallics, and inorganic compounds. Chiral HPLC separations have been observed for chemical classes previously thought difficult or impossible to resolve by liquid chromatography, for example, small compounds with molecular weights of less than 300 Da, molecules with strong amine groups, and molecules with chiral centers “buried” behind sterically hindered or fatty side chains. Non-limiting examples of difficult-to-resolve molecules that can be separated chirally using columns as described in one or more embodiments herein include aliphatic alcohols, such as 2-heptanol, 2-methyl-1-butanol, 2-pentanol and 2-butanol; propargylic alcohols, such as 3-butyn-2-ol or 1-hexyn-3-ol; aliphatic amino alcohols, such as 2-amino-1-butanol and 2-amino-1-pentanol; small molecules with no aromaticity or ring structure, such as 3-butyn-2-ol; chiral hydrocarbons, such as phellandrene; sec-butyl acetate; chiral fragrance chemicals, such as alkaloids and terpenes; molecules that absorb to silica without a chiral preference, such as nicotine and other alkaloids; and pharmaceutical compounds, such as fluoxetine and thalidomide.

Chiral HPLC columns made with media as described in one or more embodiments herein also advantageously provide improved capacity compared to currently available HPLC columns. HPLC columns packed with currently available chiral media or stationary phases generally do not have a high capacity per run. Typically less than about 50 μg to about 100 μg of analyte can be injected onto a column containing about 1.5 g to about 2 g of stationary phase before significant degradation of peak shape and column resolution occurs. Due to the limited selectivity and capacity of currently available chiral HPLC columns, large numbers of HPLC runs typically are required for gram scale purifications.

In other embodiments, finely divided particles of the chiral material, in either swollen or dried form, are used as an additive or filler in coatings or polymeric materials. The particles of chiral material make the polymers and coatings chirally selective. For example, in certain embodiments, a chirally selective filled polymer is created. In some instances, a polymer is selected that dissolves in a solvent that swells the particles of chiral material, but does not dissolve them. Alternatively, a polymer is used that dissolves in a solvent that wets the particles of chiral material, but does not substantially swell them. The polymer has sufficiently high molecular weight that it is too big to substantially enter and block the chiral pores or channels of the particles of chiral material. Typically, the polymer has a radius of gyration greater than about 50% of the pore or channel diameter of the particles of chiral material. The radius of gyration is determined for the solvent to be employed, using either published values, or well-accepted experimental techniques, such as dynamic light scattering and static light scattering Zimm plots, gel permeation chromatography, or high frequency low strain dynamic mechanical rheological measurements. Statistical measures of polymer radius of gyration as a function of polymer length (molecular weight), polymer chemistry, and solvent are well known in the art, and can be found, for example, in Polymer Handbook (Brandup, Immergut, and Grulke, Eds., John Wiley & Sons (4th Ed., 1999)).

In some embodiments, for coating applications, the particle size of the chiral material is less than about 50 microns, for example, less than about 10 microns, or less than about 5 microns. However, in some instances in chiral filled materials, larger or smaller particles are employed.

Chiral materials made as described in one or more embodiments herein also are useful as chiral containers for chemical reactions. The chirality of small volumes within the material imparts a chiral bias to reactions that occur inside the material. In at least some embodiments, the high curvature of interior chiral channels or volumes with a length scale about 0 to about 3 orders of magnitude larger than small molecule reactants biases the stability of different enantiomers of the reactants. The activation energy and stability of the activated complex, stability of the products, and reaction kinetics differ for different reacting enantiomers and chiral reaction products. In at least some instances, the difference in configurational entropy due to the available configurations for a population of chiral molecules in a small chiral environment is significant, and splits the thermodynamic energy equations for enantiomers. In certain embodiments, flow rates of different species through the chiral material also provide kinetic control of reactions. Such kinetic “flow through” control is possible even in cases where the interior material volumes are too large or the curvature too small to significantly bias the chirality of a given reaction.

In certain embodiments, one or more enzymes or catalysts is immobilized in a chiral material made as described in one or more embodiments herein. Strong monolithic hydrogels are particularly suited for such applications. In some instances, the chemical difference between the enzyme or catalyst and the polymer forming the basis of a chiral gel, along with configurational entropy effects, segregates the enzyme or catalyst into voids in the chiral gel. In some embodiments, the gel has a large pore or channel size, on the order of about 30 nm to about 100 nm. This open framework of pores or channels facilitates diffusion of large molecules (e.g., organometallic catalysts or biological enzymes) into the gel. In some instances, once a desired concentration of catalyst or enzyme has entered the gel, it is dried or placed in a solvent that decreases swelling. This reduces the pore or channel size, effectively trapping (but not necessarily binding) the catalyst or enzyme inside the material. The pore and channel diameter of the material containing the trapped catalyst or enzyme is still large enough not to perturb the geometry of large catalytic molecules. The chiral environment inside the pockets or channels of the chiral material enhances the chiral selectivity of chiral catalysts and in some instances makes an achiral catalyst exhibit chirally biased catalytic activity.

Different activated states of reactants and different conformational states of a chiral catalyst are expected to be preferentially stabilized in an environment with chiral physical features on the length scale of a molecule, when compared to a more symmetric environment. The chiral selectivity of the gel medium alters the balance of reactants transported to the supported enzyme or catalyst. This change in reactant ration for chiral (racemic) reactants is expected to alter the effective selectivity and chiral specificity of the enzyme or catalyst. By way of non-limiting example, in certain embodiments a chiral catalyst for polymerization is embedded in a membrane of chiral material. Chirally biased transport of monomers and stabilization of a preferred chirality (for monomers that readily racemize) is used to direct catalysis and subsequent regularity and purity of the product polymer.

In certain embodiments, a membrane of chirally selective material prepared as described in one or more embodiments herein is employed in a “process intensification” format using centrifuge motion to generate radial force. The chirally selective material is fabricated as a membrane and annealed, retained in a partially hydrated state, sectioned, or plasticized to impart flexibility. The flexible membrane is suitable for use in a “process intensification” format, where reactants, analytes, or other species are spun rapidly on a disk to improve transport. As a single membrane, sieve or filter, the chirally selective material allows only some analytes to pass to a radius of the disk outside a circle, disk or cylinder of the material incorporated into the intensified process. Diffusion through the material is chirally selective. Several approaches are possible for cleaning the membrane (reversing the flow) to reduce potential fouling, and recovering the enantiomers that do not pass through. In one approach, an increase in the spin rate is used to generate more velocity until the less favored enantiomers have enough momentum to pass through the membrane, filter, disk, or “sieve” of chirally selective material. In another approach, a semiflexible chirally selective material is fabricated as a Möbius strip, with each loop of the figure eight covering a separate process intensification spinning disk. In this format, one loop presents one surface as the inner surface and allows one enantiomer to pass through, while the other enantiomer is left behind on the strip's inner surface. In the other loop, the inner and outer surfaces of the Möbius band membrane are interchanged. Thus, the retained species are on the outside in this part of the process, and are easily removed without passing through the membrane.

The chiral selectivity of the material employed in various embodiments depends on the application, and the number of effective separation stages. For example, in applications such as thin layer chromatography, slow diffusion of analytes through the thin layer of chromatographic material provides a large number of effective separation stages, amplifying even a weak material selectivity. For certain non-chromatographic separations, however, stronger chiral selectivity may be desired, e.g., where the chiral material spends less time in contact with an analyte. In some embodiments, the chiral selectivity of a material is evaluated by briefly exposing an analyte solution to a chirally selective material in a vessel with stirring. The chirally selective material is removed, and the enantiomeric excess (% EE) present in the analyte following separation is measured.

In certain embodiments, the applications for which the material is suitable are determined based on the EE observed in the initial evaluation. By way of non-limiting example, if the EE observed is less than about 3%, the chiral material still may be suitable for use in chromatographic applications, such as thin layer chromatography, and for use as fillers or additives for polymeric materials. If the EE is about 3% to about 5%, the material typically is suitable for use in non-chromatographic applications, such as multi-stage filter or membrane systems, but may require about 25 separation stages or more to obtain a final separation EE greater than about 80% to about 90%. A material that produces 15% EE or greater in the initial evaluation typically is suitable for use in non-chromatographic applications, such as filters or membrane systems employing about 10 to about 20 separation stages or fewer. A material that produces about 80% EE or greater in the initial evaluation typically is useful for more demanding applications, such as, for example, systems in which the material provides a chiral environment that chirally influences reaction kinetics and thermodynamics and imparts chiral selection to the transport of reactants and products.

The following non-limiting examples further illustrate certain embodiments.

### EXAMPLE 1

### Preparation of Chiral Material with Dialysis

Washing Raw Material

3500 ml tap water with 0.022 M Na₂CO₃ and 8 g sodium dodecyl sulfate was heated until boiling. 100 g silkworm cocoons were added, and the base solution temperature was controlled between 95° C. and 100° C. for 45 minutes. Using tap water, sericin was washed from the silkworm cocoons until the pH was 7. The sericin-free silkworm cocoons were dried by spinning and placement in a hood at room temperature. After two days, the dried sericin-free silk was removed from the hood. The weight of silk recovered was about 70% to 73%.

Sol Generation

350 ml of 9.3 M LiBr solution was heated to about 65° C. to 75° C. Silk recovered from washing in the previous step was added slowly, for a total time of about 1 hour, until all of the silk dissolved. Solutions were prepared with between 10% and 40% silk by weight. Temperature during dissolution was not allowed to exceed 75° C., and dissolution time was limited to one hour, so that the resultant sol would not be too deep in color. The solution was cooled down to room temperature, forming a viscous sol.

Dialysis

The viscous sol formed in the previous step was placed in dialysis tubing (3500 molecular weight cut off (MWCO)). The sol was dialyzed in tap water for one day. In some cases, filtration was performed at this point, depending on the quality of the sol resulting from the source material. The sol was then placed in new dialysis tubing (3500 MWCO) and dialyzed for three days in deionized (DI) water. The DI water was changed every day. When the sol's conductivity dropped to about 300 mHo, the sol was filtered using a 150 nm sieve.

Gel Formation

The dialyzed sol from the previous step was stirred at room temperature for one hour. 20.7 ml of 0.5 N HCl was added, and the sol was cast into a plastic container. The container was kept at room temperature overnight until a white gel formed. The gel was annealed by placement in water or EtOH in an oven at 55° C. for 24 hours. In some experiments, the recovered gel was transferred to a sealed container with a solvent for storage. Alternatively, the recovered gel was dried for 48 hours in a hood at room temperature to form a resin. The resin was then used as prepared or ground to form a powder.

Grinding, Washing and Drying

For a dried gel (resin) to be used in powdered form, the resin was ground in a coffee grinder to 355 μm, using a standard test sieve to verify the particle size. The ground resin was washed with tap water (25 ml water/1 g resin). The resin in tap water was stirred at room temperature until there was no change in conductivity (about one hour). The water was changed and further washing was performed with deionized water after the conductivity came down to about 600 mHo (the conductivity of tap water). Two washes were performed in DI water, until the conductivity was about 25 mHo to 50 mHo (the conductivity of DI water). The wash solution was filtered each time the water was changed. A final wash was performed using 2-propanol. The resin was filtered, placed into reusable dishes, dried in a hood at room temperature overnight, and then dried under vacuum for one hour.

### EXAMPLE 2

### Preparation of Chiral Material Without Dialysis

Washing Raw Material

3500 ml tap water with 0.196 M Na₂CO₃ was heated until boiling. 100 g silkworm cocoons were added, and the base solution temperature was controlled between 95° C. and 100° C. for 30 minutes. The cocoons were washed in tap water, and then washed again in 1750 ml tap water with 0.098 M Na₂CO₃, with temperature controlled to 95° C. to 100° C. for 30 minutes. Using tap water, sericin was washed from the cocoons until the pH was 7. The sericin-free cocoons were dried by spinning and placement in a hood at room temperature. After 2 days, the dried sericin-free silk was removed from the hood. The weight of the silk recovered was about 69%.

Sol Generation

103.5 ml of 9.3 M LiBr solution was heated to about 65° C. to 75° C. Silk recovered from the previous washing step was added slowly, for a total time of about 1 hour, until all of the silk was dissolved. The temperature was not allowed to go higher than 75° C. in order to prevent the color of the resultant sol from darkening. The solution was cooled to room temperature. 241.5 ml water was added and slowly stirred until everything dissolved. Another 641 ml water was then added, and again slowly stirred until everything dissolved. The solution was filtered, first by a 150 μm sieve, and then by a 75 μm sieve to remove impurities.

Gel Formation

33.56 ml of 2 N HCl was added to the sol from the previous step. The mixture was stirred at room temperature (or at 60° C.) for one hour, and then cast into a plastic container. The container was placed in an oven at 55° C. overnight, until a gel formed. The gel was annealed by placing tap water on top of it for 24 hours. The tap water was changed three times to remove LiBr. The gel was then placed in a reusable dish, and dried in hood at 23° C.

Gel Formation with Crosslinking

In some experiments, instead of the foregoing gelling procedure, a crosslinked gel was formed by preparing the gel in the presence of a crosslinking agent. In some cases, poly (propylene glycol) diglycidyl ether (PGDE) was used as the crosslinking agent. 5.52 g of PGDE and 28 ml of 2 N HCL were added to the sol. The mixture was stirred at 60° C. for one hour, and cast into a plastic container. The container was placed in an oven at 55° C. overnight, until a gel formed. The gel optionally was annealed as described above.

In some experiments, citric acid was used as the crosslinking agent. 5.52 g citric acid and 7 ml of 2 N HCl were added to sol. The mixture was stirred at 60° C. for one hour, and cast into a plastic container. The container was placed in an oven at 55° C. overnight, until a gel formed. The gel optionally was annealed as described above.

Grinding, Washing and Drying

The gel formed with or without crosslinking was recovered and transferred to a sealed container with a solvent for storage. Alternatively, the recovered gel was dried for 48 hours in a hood at room temperature to form a resin. The resin was then used as prepared or ground to form a powder. In some experiments, the resin was ground in a coffee grinder to 355 μm, using a standard test sieve to verify the particle size.

The powder was washed in tap water (1 g powder in 25 ml water), stirred at room temperature for 5 minutes, and filtered, until the conductivity came down to about 600 mHo (conductivity of tap water). Washing was then performed in DI water, generally two times, until the conductivity was about 25-50 mHo (conductivity of DI water). At this point, LiBr was almost washed out of the material. A final wash was performed in 2-propanol (1 g of powder with 25 ml 2-propanol), stirred at room temperature for 30-60 minutes, and filtered. Additional aliquots of 2-propanol were used to rinse the material three more times. The chiral powder was filtered, placed in a reusable dish, and dried in a hood at room temperature overnight. The dried powder was further heated in a vacuum oven at 55° C. for one hour, and cooled to room temperature in a desiccator cabinet. Chiral powders of desired particle size then were obtained by further grinding using a coffee maker. The reground powders were sized by passing through standard test sieves of 355, 250, 150 and 25 μm.

### EXAMPLE 3

### Standard Test for Chiral Selectivity

The stability of a chiral material was evaluated, and the material was tested for its chiral selectivity against various test samples containing more than one enantiomer. Each test sample was either a racemic mixture or a mixture having less than 100% enantiomeric excess (EE) of one enantiomer.

First, the stability of the chiral material was determined by measuring the rotation of a clean non-chiral solvent that does not spontaneously rotate light before and after exposure to the material. The material was determined to be stable (no substantial sloughing of chiral molecules or particles from the material into the solvent) if the solvent light rotation was unchanged after exposure to the chiral material.

After stability testing, the chiral material was tested against racemic DL-lysine as a control. The chiral material was contacted with a racemic DL-lysine solution for 3-10 minutes. The enantiomeric excess of the lysine remaining in solution was estimated from the starting concentration of lysine in solution, the observed rotation, and the standard rotation of lysine. The chiral material was awarded a score based on its ability to separate the enantiomers of lysine. The rating scale was as follows: 1=complete separation in 1 stage (i.e., one repetition of contacting the material with lysine); 2=complete separation in 3 to 4 stages; 3=complete separation in 10 or more stages.

The chiral material was then tested for its chiral selectivity against various test samples containing more than one enantiomer. Each test sample was contacted with the chiral material under conditions (e.g., pH) where the chiral material was stable. The chiral material was either in solution or dry. The test material was either a neat liquid, an oil, or a solution. The chiral material was contacted with the test material for 3-10 minutes. The enantiomeric excess of the test compound after contacting the chiral material was estimated from the starting concentration of test compound, the observed rotation, and the standard rotation of the test compound.

The chiral selectivity of a chiral material made as described in Example 1 was tested in this way. Each test sample was contacted with the chiral material under conditions as set forth in Table 1. The chiral selectivity results are summarized in Table 1. The lysine score of the chiral material under the test conditions is listed for comparison.

TABLE 1

| | | | Selectivity | |
|---|---|---|---|---|
| | | | index | |
| | | | (enantiomeric | |
| Test compound | Solvent | pH | excess %) | Score* |
| Catechin hydrate | EtOH:H₂O (1:3) | | 56 | 3 |
| Benzoin | IPA:H₂O (4:0.6) | 6 | 56 | 2 |
| Clenbuterol | EtOH:H₂O (50:50) | | 44 | 2 |
| DL-tocopherol | EtOH:H₂O (50:50) | 7 | 44 | 2 |
| Sec-butyl acetate | EtOH:H₂O (50:50) | | 56 | 3 |
| DL-histidine | EtOH:H₂O (50:50) | 6 | 56 | 2 |
| Troger's base | EtOH:H₂O (50:50) | 6 | 44 | 2 |
| DL-camphor | EtOH:H₂O (50:50) | 6 | 44 | 2 |
| DL-methionine | EtOH:H₂O (50:50) | 6 | 44 | 3 |
| α-phellandrene | No solvent | 6 | 42 | 1 |
| Ru(bipy)₃Cl₂ | EtOH:H₂O (50:50) | | 44 | 2 |
| Thalidomide | No solvent | | 42 | 2 |
| Limonene | Dioxane:water (80:20) | 6 | 40 | 1 |
| Carvone | EtOH:H₂O (3:1) | 6 | 56 | 1 |
| Terpine mixed | EtOH:H₂O (50:50) | 6 | 56 | 2 |
| isomer | | | | |
| α-terpineol | EtOH:H₂O (50:50) | | 18 | 1 |

*Scores:
1 = Separation achieved in one stage
2 = Separation achieved in 3-4 stages
3 = Separation required ten or more stages

### EXAMPLE 4

### Chiral Separation of Organic Compounds

A chiral material made as described in Example 1 was ground and packed into an HPLC column. A slurry was made using 1 g of chiral material in 3 ml of 90% hexane and 10% isopropanol. The slurry was pumped at 0.5 ml/min to fill a column 2.5 cm long and 0.5 mm in inner diameter. The pressure was about 90 psi. The filled column was placed on an HPLC instrument using the same solvent and a flow rate increasing every 10 minutes from 0.5 to 1 to 1.5 to 2 ml/min. The initial pressure of 90 psi increased to about 500 psi. If an air gap resulted, it was left in the case of water-based systems, or filled with additional chiral material to achieve a tight packing in non-water-based systems.

Benzoin

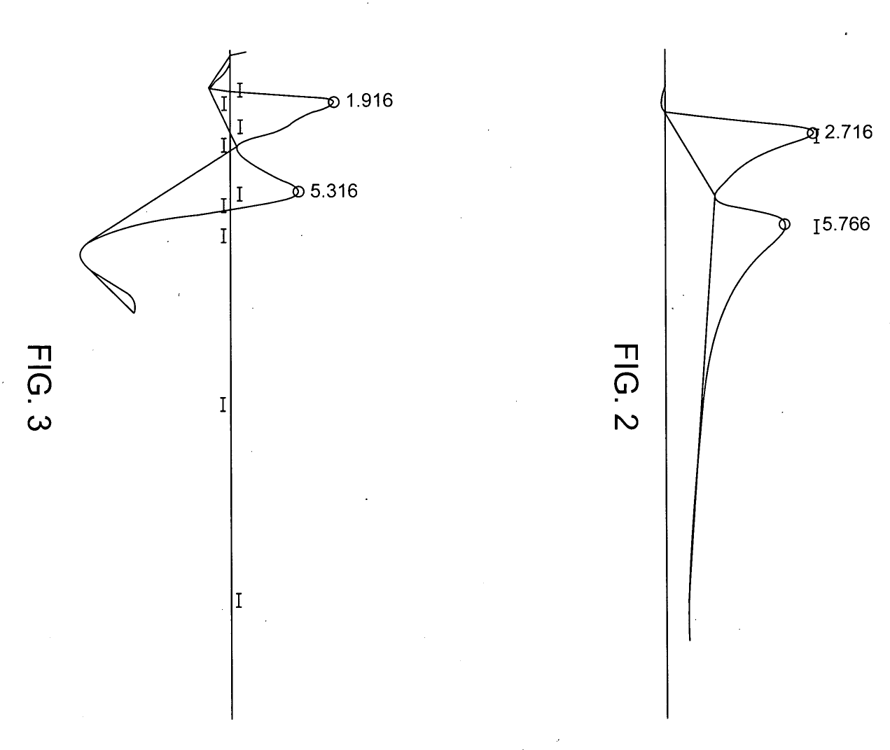

Separation of benzoin was performed using an HPLC column packed as described above with chiral medium ground to a particle size of 25 μm or less. The mobile phase for HPLC was 90:10:0.25 hexane:isopropanol:acetic acid, and the flow rate was 1.0 ml/min at a pressure of 276 psi. UV direction was performed at 254 nm. Run time was 20 minutes. The results are summarized in Table 2, and the chromatogram is shown in FIG. 2.

TABLE 2

| Component | Retention | Area | Height |
|---|---|---|---|
| 1 | 2.716 | 347.211 | 4.545 |
| 2 | 5.766 | 361.3235 | 2.408 |

DL-Lysine

Separation of DL-lysine was performed using an HPLC column packed as described above with chiral medium ground to a particle size of 355 μm or less. The mobile phase for HPLC was 70:30 CH₃)H:H₂O plus 0.01% phosphoric acid, and the flow rate was 1.0 ml/min at a pressure of 570 psi. UV detection was performed at 210 nm. Run time was 10 minutes. The results are summarized in Table 3, and the chromatogram is shown in FIG. 3.

TABLE 3

| Component | Retention | Area | Height |
|---|---|---|---|
| 1 | 1.916 | 284.823 | 4.076 |
| 2 | 5.316 | 452.195 | 4.421 |

As will be apparent to one of ordinary skill in the art from a reading of this disclosure, the present invention can be embodied in forms other than those specifically disclosed above. The particular embodiments described above are, therefore, to be considered as illustrative and not restrictive. The scope of the invention is as set forth in the appended claims, rather than being limited to the examples contained in the foregoing description.

What is claimed is:

1. A method for producing a chirally selective material, the method comprising:
(a) dissolving a polymer in an interactive solvent to generate a sol,
wherein the polymer includes at least about 30% chiral monomers of the same chiral orientation, and
wherein the sol includes at least about 3 weight % polymer;
(b) dialyzing the sol to remove a component of the interactive solvent;
(c) introducing a crystallization inhibitor into the dialyzed sol; and
(d) allowing the sol to form a chiral gel.

2. The method of claim 1, wherein the gel has a substantially homogeneous chiral structure.

3. The method of claim 1, wherein gel formation is not initiated at an interface between the sol and an immiscible liquid.

4. The method of claim 1, wherein the sol is cast into a container to obtain a gel having the shape of the container.

5. The method of claim 1, wherein the gel is formed at a temperature between about 15° C. and about 50° C.

6. The method of claim 1, wherein the sol includes at least about 10 weight % polymer.

7. The method of claim 1, wherein the sol includes at least about 15 weight % polymer.

8. The method of claim 1, wherein the interactive solvent comprises an aqueous salt solution that maintains separation between the polymer molecules in solution, but does not denature the polymer molecules.

9. The method of claim 8, wherein the salt is selected from the group consisting of sodium salts, potassium salts, calcium salts, lithium salts, magnesium salts, manganese salts, and mixtures thereof.

10. The method of claim 8, wherein dialyzing the sol removes at least about 60% of the salt.

11. The method of claim 1, wherein the crystallization inhibitor is selected from the group consisting of acids, bases, and salts.

12. The method of claim 11, wherein the crystallization inhibitor is an acid or a base.

13. The method of claim 11, wherein the crystallization inhibitor is selected from the group consisting of hydrochloric acid, acetic acid, nitric acid, phosphoric acid, carbonic acid, formic acid, propionic acid, sulfuric acid, trifluoroacetic acid, AlCl₃, FeCl₃, and mixtures thereof.

14. The method of claim 11, wherein the crystallization inhibitor is selected from the group consisting of salts of hydroxides, phosphates, carbonates, and mixtures thereof.

15. The method of claim 1, further comprising washing the gel.

16. The method of claim 1, further comprising drying the gel to form a resin.

17. The method of claim 16, further comprising grinding the resin to form particles.

18. The method of claim 1, further comprising annealing the gel.

19. The method of claim 18, wherein annealing is performed in an annealing solvent.

20. The method of claim 19, wherein the annealing solvent comprises an alcohol.

21. The method of claim 18, wherein annealing is performed at a temperature between about 15° C. and about 70° C.

22. The method of claim 1, further comprising contacting the gel with a chemical modification agent to chemically functionalize the gel.

23. The method of claim 22, wherein the chemical modification agent is selected from the group consisting of silanizing agents, crosslinking agents, hydrophobic coating agents, coupling agents, and mixtures thereof.

24. The method of claim 22, wherein the chemical modification agent is a crosslinking agent.

25. The method of claim 1, further comprising immobilizing an enzyme or catalyst in the gel.

26. The method of claim 1, wherein the polymer is a naturally occurring polymer.

27. The method of claim 26, wherein the polymer is a collagen, keratin, silk, seroin, or chorion.

28. The method of claim 26, wherein the polymer originates from a species of Bombyx, Antherea, Gonometa, Borocera, Anaphe, Argemia, Argiope, Tetragnatha, Gasteracantha, Araenea, Nephila, Embiidina, or Hymenoptera.

29. The method of claim 1, wherein the sol is concentrated.

30. A chirally selective material made by the method of claim 1.

31. A method for producing a chirally selective material, the method comprising:
(a) dissolving a polymer in an interactive solvent to generate a sol,
wherein the polymer includes at least about 30% chiral monomers of the same chiral orientation, and
wherein the sol includes at least about 10 weight % polymer;
(b) introducing a crystallization inhibitor into the sol; and
(c) allowing the sol to form a chiral gel.

32. The method of claim 31, wherein the gel has a substantially homogeneous chiral structure.

33. The method of claim 31, wherein gel formation is not initiated at an interface between the sol and an immiscible liquid.

34. The method of claim 31, wherein the sol is cast into a container to obtain a gel having the shape of the container.

35. The method of claim 31, wherein the sol includes at least about 15 weight % polymer.

36. The method of claim 31, wherein the sol includes at least about 20 weight % polymer.

37. The method of claim 31, wherein the weight ratio of crystallization inhibitor to polymer is greater than about 5%.

38. The method of claim 31, wherein the gel is formed at a temperature between about 30° C. and about 60° C.

39. The method of claim 31, wherein formation of the gel from the sol takes at least about 4 hours.

40. A chirally selective material made by the method of claim 31.

41. A preformed article comprising a cast or molded chirally selective material, wherein the chirally selective material comprises a polymer including at least about 30% chiral monomers of the same chiral orientation, and wherein the polymer forms a multilayered structure having internal chiral pores or channels, wherein the pore or channel diameter is between about 5 nm and about 50 nm.

42. The article of claim 41, wherein the chirally selective material has a substantially homogeneous chiral structure.

43. The article of claim 41, wherein the chiral structure of the chirally selective material lacks an alignment effect that competes with chiral twisting in the material.

44. The article of claim 41, wherein the chirally selective material is a gel.

45. The article of claim 41, wherein the chirally selective material is a resin.

46. The article of claim 41, wherein the pore or channel diameter is between about 5 nm and about 30 nm.

47. The article of claim 41, wherein the chirally selective material is a liquid crystalline ordered solid.

48. The article of claim 41, wherein the multilayered structure includes layers of molecularly oriented polymer defining an interlayer region including chiral pores or channels having a diameter between about 5 nm and about 30 nm.

49. The article of claim 41, wherein the chirally selective material is crosslinked.

50. The article of claim 41, wherein the polymer is a naturally occurring polymer.

51. The article of claim 50, wherein the polymer is a collagen, keratin, silk, seroin, or chorion.

52. The article of claim 41, wherein the internal chiral pores or channels are chemically modified.

53. The article of claim 41, wherein the internal chiral pores or channels are coated with an agent to modify the surface properties of the chiral pores or channels.

54. The article of claim 41, wherein the chirally selective material comprises an enzyme or catalyst immobilized in the material.

55. The article of claim 41, wherein the chirally selective material is in the form of a membrane.

56. A method of performing chiral separation comprising:
(a) contacting a mixture of enantiomers with a chirally selective material,
wherein the chirally selective material comprises a polymer including at least about 30% chiral monomers of the same chiral orientation, and
wherein the polymer forms a multilayered structure having internal chiral volumes that are between about 4 and about 60 times the size of the enantiomers to be separated; and
(b) isolating predominantly a first enantiomer within the chirally selective material.

57. The method of claim 56, further comprising extracting the first enantiomer isolated within the chirally selective material.

58. The method of claim 56, wherein contacting the mixture of enantiomers with the chirally selective material comprises allowing the enantiomers to diffuse selectively into the material in a solvent.

59. The method of claim 58, further comprising recovering predominantly a second enantiomer from the bulk solvent.

60. The method of claim 56, wherein the chirally selective material has a substantially homogeneous chiral structure.

61. The method of claim 56, wherein the chiral structure of the chirally selective material lacks an alignment effect that competes with chiral twisting in the material.

62. The method of claim 56, wherein the internal chiral volumes are between about 20 and about 50 times the size of the enantiomers to be separated.

63. The method of claim 56, wherein the chirally selective material forms a membrane, and wherein predominantly a first enantiomer is isolated within the membrane and predominantly a second enantiomer passes through the membrane.

64. A chiral separations column comprising a chirally selective material, wherein the chirally selective material comprises a polymer including at least about 30% chiral monomers of the same chiral orientation, and wherein the polymer forms a multilayered structure having internal chiral pores or channels, wherein the pore or channel diameter is between about 5 nm and about 50 nm.

65. The column of claim 64, wherein the chirally selective material has a substantially homogeneous chiral structure.

66. The column of claim 64, wherein the chiral structure of the chirally selective material lacks an alignment effect that competes with chiral twisting in the material.

67. The column of claim 64, wherein the chirally selective material is in the form of a cast or molded preformed article.

68. The column of claim 64, wherein the chirally selective material is in the form of particles.

69. The column of claim 68, wherein the particles have a size of about 25 microns or less.

70. The column of claim 64, wherein the column provides a separation efficiency greater than about 10% EE.

71. The column of claim 64, wherein the chirally selective material is crosslinked.

72. The column of claim 64, wherein the chirally selective material is swollen in a solvent.

73. A composition comprising a chirally selective material, wherein the chirally selective material comprises a polymer including at least about 30% chiral monomers of the same chiral orientation, and wherein the polymer forms a multilayered structure having internal chiral pores or channels, wherein the pore or channel diameter is between about 5 nm and about 50 nm, and wherein the chiral structure of the chirally selective material lacks an alignment effect that competes with chiral twisting in the material.
